(19) United States
(12) Patent Application Publication
(10) Pub. No.: US 2006/0023098 A1
(43) Pub. Date: Feb. 2, 2006

(54) Driving circuit for charge coupled device

(76) Inventors: Thomas Graen, Darmstadt (DE); Reinhard Kirschenstein, Rossdorf (DE); Matthias Zeidler, Dieburg (DE)

Correspondence Address: THOMSON LICENSING INC., PATENT OPERATIONS, PO BOX 5312, PRINCETON, NJ, 08543-5312, US

(21) Appl. No.: 10/909,501

(22) Filed: Aug. 2, 2004

(51) Int. Cl. H04N 5/335

(52) U.S. Cl. 348/311

(57) ABSTRACT

The present invention provides a driving circuit for driving an electronic device, a method of driving an electronic device and a corresponding electronic device including such a driving circuit. The inventive driving circuit is adapted to generate a first and a second clock signal in a push-pull mode. In one embodiment first and second clock signals are generated by respective driver modules and are subject to a push-pull mode coupling provided by a coupling module. Moreover, embodiments of the inventive driving circuit include inductive elements that form a resonant circuit with the internal capacitance of the charge coupled device. The resonant frequency of the resonance circuit substantially equals the frequency of the clock signals, thus effectively allowing for reduction of power consumption of the driving circuit.

### FIELD OF THE INVENTION

The present invention relates to the field of electronic driving circuits for charge coupled devices (CCD).

### BACKGROUND OF THE INVENTION

Charge coupled devices (CCD) are widely used in image acquisition. Typically, CCD sensors provide efficient transformation of light into electrical signals. CCD sensors feature a plurality of light sensitive pixels that are preferably arranged in a one dimensional or two dimensional array. The various pixels of a CCD sensor are adapted to accumulate electrical charges proportional to an intensity of incident light. In this way a spatial light pattern, e.g. an image, acquired by a CCD sensor is typically transformed into a corresponding pattern of electrical charges. This electrical charge pattern has to be read out, hence charge packets that are separately stored by means of the pixels or adjacently positioned capacitive elements, have to be transported to an output node of the CCD.

Typically, charge transport of either-one dimensional bucket brigade delay lines or two dimensional CCD arrays are realized by means of vertical and/or horizontal shift registers. In this way each charge packet accumulated by the various pixels of the CCD sensor is consecutively shifted to a neighboring capacitive element until it reaches the output node of the CCD sensor. The output node typically provides amplification of each separate charge packet, thus allowing for efficient and reliable further signal processing.

Shifting of acquired electrical charges is typically performed on the basis of regular time intervals that are specified by a clocking of the CCD sensor.

A plurality of different clocking schemes for CCD sensor readout exists, such as two phase clocking, three phase clocking, four phase clocking or other clocking arrangements making use of binning, i.e. combining charge packets from a number of neighboring pixels before sending them to the output amplifier. In principle, these clocking schemes are based on alternately switching of adjacently positioned storage gates to lower and higher voltages, respectively. In this way potential barriers are step-wise shifted in either horizontal or vertical direction, thus allowing for effective shifting of charge packets to neighboring pixels or capacitive elements. Depending on the clocking scheme, the total number of pixels of a CCD sensor as well as the frame rate of image acquisition, the clocking frequency may be as high as several tens or hundreds of MHz.

Typically, a CCD sensor comprises two clocking electrodes that allow for efficient and universal driving of the CCD sensor by means of an external clocking circuit. Hence, a clocking signal, i.e. a driving signal for the CCD readout, does not have to be generated by the CCD sensor itself. In this way a plurality of CCD based configurations can be realized by making use of a single type of CCD chip. However, clocking of the various separate CCD pixels is realized by the CCD sensor itself in response to receiving the external clocking signal.

External clocking of a CCD sensor that has two clocking electrodes is typically based on clocking signals in push-pull mode. This implies that the first and second clocking signals that are applied to respective first and second clocking electrodes of the CCD sensor are inverted signals, i.e. the first clocking signal substantially equals the inverted second clocking signal.

However, the two clocking signals typically comprise asymmetric components, i.e. time intervals of rising and falling edges of the two clocking signals do only partially overlap, or are not fully symmetric. Hence, the intersection points of the two clocking signals in push-pull mode are typically shifted with respect to the zero point. Consequently, the two clocking signals feature common mode components or a DC offset that is disadvantageous for the charge carrier transport across the CCD sensor. In particular, due to common mode components of the clocking signals referred to the CCDs substrate, the quality of the CCD sensor output may be seriously affected.

### SUMMARY OF THE INVENTION

Various embodiments of the invention provide an electronic circuit for driving an electronic component. The electronic circuit comprises a clock signal generator coupled to a driving unit. The driving unit provides at least first and second clock signals based upon a clock signal from said clock signal generator. The second clock signal is inverted compared to the first clock signal, A coupling module push-pull couples the first and the second clock signals.

### BRIEF DESCRIPTION OF THE DRAWINGS

In the following preferred embodiments of the invention will be described in detail by making reference to the drawing in which

FIG. 1 shows a block diagram schematically illustrating the inventive driving circuit;

FIG. 2 shows a schematic example of an ideal driving signal;

FIG. 3 depicts a first example of an imperfect driving signal;

FIG. 4 illustrates a second example of an imperfect driving signal; and

FIG. 5 shows a third example of an imperfect driving signal.

### DETAILED DESCRIPTION OF A PREFERRED EMBODIMENT

FIG. 2 shows a representation of typical driving signal. Solid line A and dashed line B represent the CCD shift clock and the inverse CCD shift clock, respectively. The dash-dotted line C represents the common mode component of the CCD shift clock. The duty cycle and the rise and fall times, respectively, are symmetrical for lines A and B. Consequently, no common mode signal C is present, i.e. the line is flat at its zero level. It is to be noted that the zero lines are not common to the three signals.

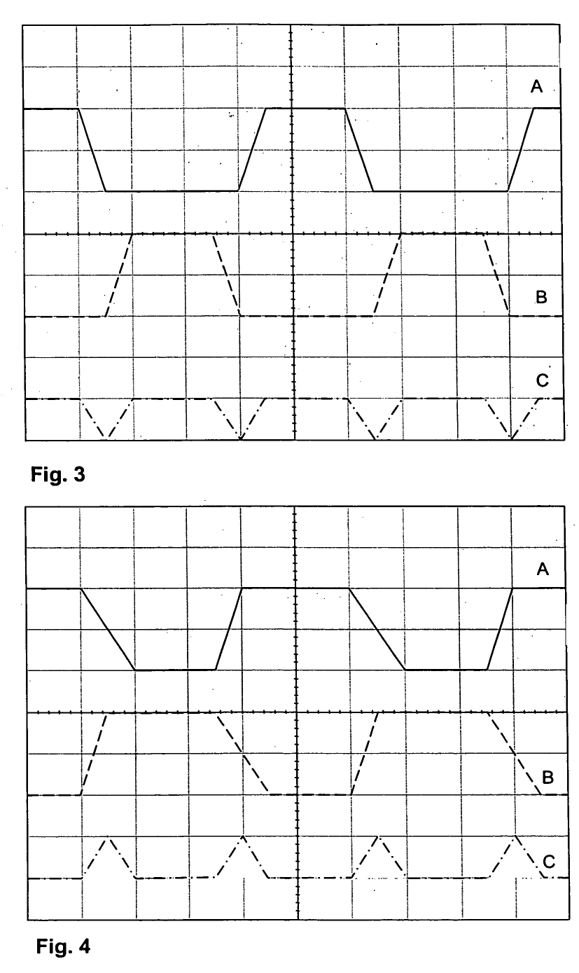

FIG. 3 shows a first example of an imperfect driving signal. The lines and their representation are the same as in FIG. 2. The duty cycles of the CCD shift clock signal A and the inverse CCD shift clock signal B differ. Consequently, the common mode signal C is no longer flat and a DC component builds up at certain times.

FIG. 4 shows a second example of an imperfect driving signal. The lines and their representation are the same as in FIGS. 2 and 3. The rise and fall times of the signals A and B are different from each other. Consequently, the common mode signal C is no longer flat and a DC component builds up at certain times.

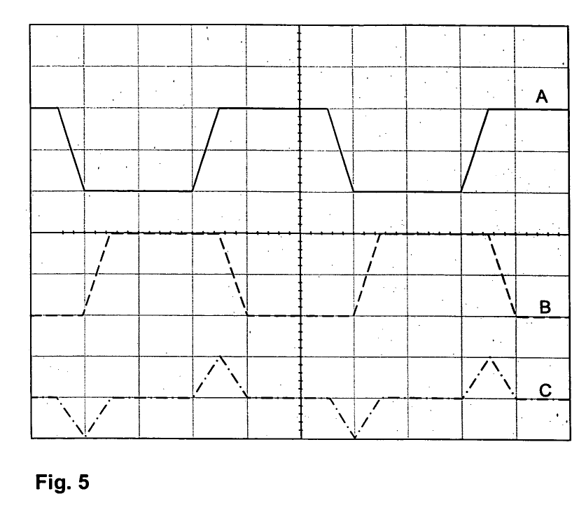

FIG. 5 shows a third example of an imperfect driving signal. As before, the lines and their representation are the same as in FIGS. 2 to 4. A time delay exists between the CCD shift clock signal and its inverse. Apart from that the signals are substantially symmetrical. However, the common mode signal C is no longer flat, but here no DC component is present. The changing signs of the common mode signal cancel each other out. Nevertheless, the common mode signal may be disturbing the connected circuitry.

Moreover, the clocking electrodes of a CCD sensor typically exhibit relatively high capacitance leading to an appreciable power loss in the driving circuit of the CCD chip.

Embodiments of the present invention provide an improved driving circuit for a charge coupled device. One embodiment provides improved push-pull coupling of the clocking signals as well as reduction of power loss.

An embodiment of the invention provides an electronic-driving circuit for driving of an electronic component by means of a first and a second clock signal. According to one embodiment, the driving circuit comprises a clock generator for generating a master clock signal. The driving circuit further comprises a driving unit that is adapted to generate the first and the second clock signals in response to receiving the master clock signal. According to one embodiment, the second clock signal is substantially equal to the inverted first clock signal.

The first and the second clock signals typically comprise common mode components. That is, time intervals of rising and falling edges of respective first and second clock signals do not completely overlap, or are not fully symmetric. Hence, the points of time at which rising and falling edges turn over to falling and rising edges do not exactly match. The driving circuit therefore further comprises a coupling module for push-pull coupling of the first and the second clock signals. The coupling module serves to appropriately delay one of the first and second clock signals in such a way that time intervals of falling and rising edges of the first and second clock signals exactly overlap.

The coupling module effectively suppresses common mode components of the first and the second clock signals. In this way, the symmetry of the first and second clock signals is enhanced and the DC offset of the two clock signals is effectively reduced. In some cases the DC offset vanishes. Consequently, the electronic component can be driven by means of clock signals that are in exact push-pull mode.

According to an embodiment of the invention, the driving unit comprises at least first and second driving modules. The first and second driving modules, generating respective first and second clock signals. For example, according to one embodiment, the driving modulesare implemented as operational amplifiers that serve to amplify a master clock signal in order to appropriately drive the electronic component. According to one embodiment of the invention, at least one of the two driving modules is implemented as an inverting operational amplifier. In this way, the second clock signal becomes substantially equal to the inverted first clock signal and vice versa.

However, the electrical properties of the electrical components of the first and second driving modules can sometimes slightly deviate from each other. For example, according to one embodiment the operational amplifiers comprise Complementary Metal Oxide Semiconductor (CMOS)-transistors. Such components tend to exhibit asymmetric switching behavior. Also, these standard electronic components provide slight differences with respect to their internal resistance and capacitance. Additionally, the driving modules are operated near their high frequency operating limit, typically in the range of MHz. Voltages of several volts and an effective current exceeding one ampere are common. Consequently, asymmetries in the output signal are more likely to arise.

According to one embodiment of the invention, a coupling module serves to suppress asymmetries generated by the driving modules as well as to provide the optimal push-pull coupling of the first and the second clock signals.

Various embodiments of the invention will find broad application in drive circuits including a first and a second clocking electrode. In particular, by making use of the coupling module, an optimal push-pull coupling of first and second clock signals is realized.

According to one embodiment of the invention, the electronic component is a charge coupled device (CCD) or a CCD sensor. The CCD device is adapted to transform incident light into electrical signals. The CCD sensor typically includes a first and a second clocking electrode that are driven in push-pull mode by means of respective first and second clock signals.

According to another embodiment of the invention, the coupling module comprises a common-mode choke for rejection of common mode components of the first and second clock signals. Such a common-mode choke includes a first and a second coil having substantially identical windings on a common core. As long as the two clock signals are in push-pull mode the magnetic flux inside the core generated by the first and the second clock signals mutually cancel each other out. The net magnetic flux is zero and the inductivity of the common-mode choke is substantially zero, i.e. the common-mode choke has no noticeable impact on the two clock signals.

Whenever the first and the second clock signals have common mode components, i.e. at least a portion of the clock signals rise or fall coincident with each other, the corresponding magnetic fields no longer cancel each other out. Hence, the net magnetic flux inside the core is becomes non-zero. Consequently, the common-mode choke exhibits an appreciable inductivity that serves to delay one of the clock signals, thereby enforcing an effective push-pull mode coupling of the first and the second clock signals.

According to a further embodiment of the invention, the driving circuit further comprises at least first second inductive elements. The first and the second inductive elements and the internal capacitance of the charge coupled device are adapted to form a resonant circuit. This resonant circuit has a resonance frequency that is substantially equal to the frequency of the master clock signal. In this way, the clocking of the CCD is performed in a resonant way. In one embodiment of the invention, this is effectively realized by appropriately tuning either the frequency of the master clock signal and/or the inductivity of at least one of the first and second inductive elements. By operating the driving circuit near a resonance frequency, power loss is effectively reduced.

Moreover, in this resonant configuration, there is a possibility that the CCD sensor will be driven at a voltage exceeding the maximum output voltage of the driving unit. Compared to a non-resonant driving of the CCD sensor, an output voltage of the driving unit is effectively reduced by simultaneously maintaining a voltage, which is applied to the clocking electrodes of the CCD sensor. Advantageously, the power consumption of the entire driving circuit for clocking of the CCD sensor is effectively reduced.

However, the additional inductive elements are not necessarily present as discrete components. Depending on the capacitance present at the terminals and the desired resonance frequency, the stray inductance of the common-mode choke in conjunction with the capacitance of the terminals is sufficient for achieving the desired resonance.

According to a further embodiment of the invention, the driving circuit further comprises a first and a second resistor having a first and a second resistance. The first and the second resistors are adapted to provide damping of the resonant circuit. In this way the resonant circuit formed by the capacitance of the CCD sensor, the first and the second inductive elements and the first and the second resistors is a damped resonant circuit. Damping of the resonant circuit is particularly advantageous for interruptions of the clocking signals.

For example, when the CCD sensor is subject to charge transfer from the photo elements to shift register or when the CCD sensor is not subject to readout, generally no clocking signal has to be applied to the clocking electrodes of the CCD sensor. The first and the second resistors can be appropriately dimensioned in order to optimize the driving circuit's on- and off-switching properties.

In another aspect, the invention provides a driving method of a charge coupled device. The inventive driving method comprises the steps of: generating a master clock signal, deriving a first and a second clock signal from the master clock signal and coupling of first and second clock signals in push-pull mode. Deriving of first and second clock signals from the master clock signal is preferably performed by means of appropriate driving modules, one of which providing inverted amplification of the master clock signal. Consequently, the second clock signal only substantially equals the inverted first clock signal and vice versa. Here, the generation of the first and the second clock signal from the master clock signal is insufficient for an optimal driving of the charge coupled device. Therefore, any asymmetries and common mode components of the first and the second clock signals have to be suppressed or effectively filtered by making use of a coupling module providing coupling of the first and the second clock signals into push-pull mode.

In still another aspect, the invention provides an electronic device that has a charge coupled device and an electronic driving circuit. The charge coupled device is driven by means of a first and a second clock signal that is generated by the driving circuit. The driving circuit comprises a clock generator for generating a master clock signal, a driving unit for generating the first and the second clock signals and a coupling module for push-pull coupling of the first and the second clock signals. The first and the second clock signals are generated by means of the driving unit in response to receive the master clock signal. Typically, generation of the first and second clock signals inevitably comes along with asymmetries and common mode components.

Hence the generated second clock signal only substantially equals the inverted first clock signal. Therefore, the coupling module is adapted to effect an exact push-pull coupling of the first and the second clock signals. In this way, the coupling module of the driving circuit effectively suppresses common mode components and asymmetries of the first and second clock signals that are applied to respective first and second clocking electrodes of the CCD sensor.

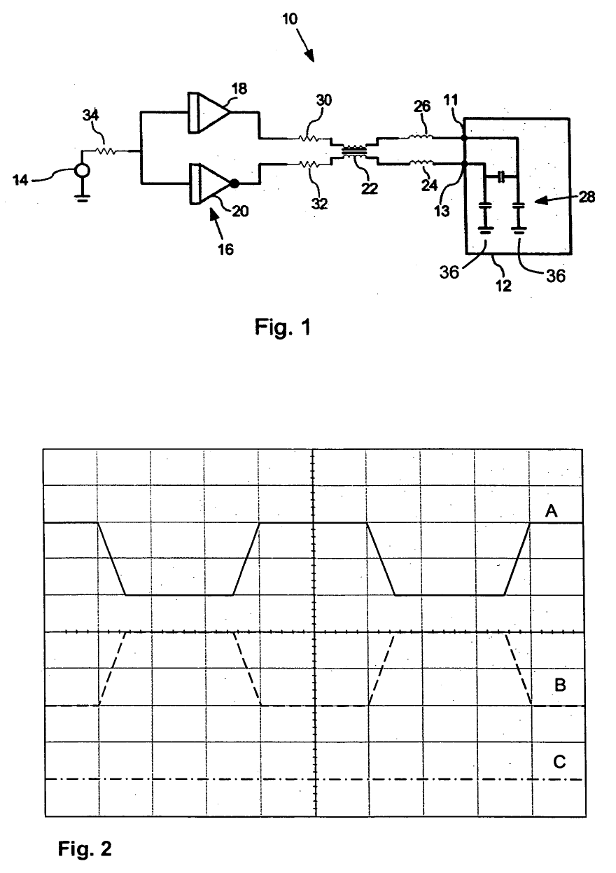

FIG. 1 schematically illustrates one embodiment of the inventive driving circuit 10. Driving circuit 10 is drives a charge coupled device (CCD) 12 by means of a first and a second clock signal. The inventive driving circuit 10 has a clock generator 14 and a driving unit 16. The driving circuit 10 further has a coupling module 22, first and second inductive elements 24, 26, first and second resistors 30, 32 and an additional resistor 34. Resistor 34 is the source resistor of the signal generator. The driving unit 16 further has a first and a second driving module 18, 20. The clock signals are generated by means of the driving circuit 10 and are coupled to the charge coupled device 12 by means of the contact electrodes 11, 13 of the CCD 12. The internal capacitance 28 of the CCD 12 is represented by means of an equivalent circuit diagram featuring three capacitors in a ri-configuration. It is to be noted that the figure depicts only a simplified schematic of a single connection to the CCD. However, the shown part of the CCD is an example of a part for which the invention is advantageously used.

A master clock signal is generated by the clock generator 14 and is provided to the first and the second driving modules 18, 20 of the driving unit 16 in parallel. According to one embodiment, the first and the second driving modules 18, 20 provide about equal amplification of the received master clock signal. However, one of the driving modules, e.g. driving module 20, provides an inverted output. In this way two clock signals for driving the CCD 12 are generated. However, due to deviations of the electronic components of the driving modules 18, 20 the generated first and second clock signals are not symmetrical push-pull signals. Typically, the first and the second clock signals are not in a strict push-pull mode and have appreciable common mode components that have a negative impact on the readout of the CCD 12.

By means of the coupling module 22 that is implemented as a common-mode choke in one embodiment of the invention, the first and the second clock signals are both coupled such that their intersection points match with the zero crossing. Further, time intervals of rising and falling edges of the first and the second clock signals more closely overlap. In this way the common-mode choke 22 serves to suppress the common mode component, or a DC offset, of the first and second clock signals. In this way, asymmetry of the first and second clock signals is effectively filtered. Consequently, the CCD 12 is driven in a more optimal push-pull mode.

The first and the second inductive elements 24, 26 and the internal capacitance 28 of the CCD 12 effectively form a resonant circuit with a particular resonance frequency. In one embodiment of the invention, the internal capacitance 28 and any of the inductive elements 24, 26 are dimensioned in such a way that the resonance frequency of the resonant circuit substantially equals the frequency of the master clock signal. In this way clocking of the CCD 12 is effectively performed in a resonant way. This allows an effective reduction of power loss and power dissipation and permits a lower output voltage of the driving unit 16. At the same time, a sufficient voltage of the clock signals applied to the first and second clocking electrodes 11, 13 of the CCD 12 is maintained. In this way power consumption for a CCD readout is effectively reduced.

The driving circuit 10 further comprises first and second resistors 30, 32. Resistors 30, 32 provide effective damping of the resonant circuit. Damping of the resonant circuit formed by the internal capacitance 28 and the first and the second inductive elements 24, 26 on the one hand limits the resonance amplitude and on the other hand provides optimization of on- and off-switching characteristics of the driving circuit. In particular, when the clocking signals are subject to interruption, a sufficient damping of the resonance is required. Optimization of on- and off-switching characteristics of the resonance circuit is realized by appropriately dimensioning the resistors 30, 32.

Consequently, the inventive driving circuit 10 provides an improved clocking of a charge coupled device 12. As will be recognized by those of ordinary skill in the art, the inventive driving circuit 10 will find application to any electronic component that is suitable for external clocking and that has a first and a second clocking electrode. In particular, by making use of the coupling module 22, an optimal push-pull coupling of first and second clock signals is realized. Moreover, in one embodiment of the invention, by making use of appropriate inductive elements, the clocking of the electronic component, e.g. the CCD sensor, is performed in a resonant mode that effectively reduces power consumption.

### LIST OF REFERENCE NUMERALS

10 driving circuit

11 contact electrode

12 charge coupled device

13 contact electrode

14 clock generator

16 driving unit

18 driving module

20 driver module

22 coupling module

24 inductive element

26 inductive element

28 internal capacitance

30 resistor

32 resistor

34 resistor

36 substrate ground

What is claimed is:

1. An electronic circuit for driving an electronic component comprising:
a clock signal generator;
a driving unit coupled to the clock signal generator and providing at least first and second clock signals based upon a clock signal from said clock signal generator, wherein the second clock signal is inverted compared to the first clock signal,
a coupling module for push-pull coupling of the first and the second clock signals.

2. The electronic driving circuit according to claim 1, wherein the electronic component is a charge coupled device.

3. The electronic driving circuit according to claim 1, wherein the coupling module comprises a common-mode choke for rejection of common-mode components of the first and second clock signals.

4. The electronic driving circuit according to claim 1, further including at least first and a second inductive elements, the first and the second inductive elements and the internal capacitance of the charge coupled device being comprising a resonant circuit having a resonance frequency being substantially equal to the frequency of the master clock signal.

5. The electronic driving circuit according to claim 4, further including at least a first and a second resistor having a first and a second resistance, the first and second resistors damping the resonant circuit.

6. A driving method for a charge coupled device, including the steps of:
generating a master clock signal,
deriving a first and a second clock signal from the master clock signal, the second clock signal being substantially equal to the inverted first clock signal,
coupling the first and second clock signals in push-pull mode by means of a coupling module.

7. The driving method according to claim 6, further including a step of driving the charge coupled device by means of a resonant circuit having a resonance frequency corresponding to the frequency of the master clock signal.

8. An electronic device having a charge coupled device and an electronic driving circuit, the charge coupled device being driven by means of a first and a second clock signal generated by the driving circuit, the driving circuit including:
a clock generator for generating a master clock signal,
a driving unit for generating at least first and second clock signals in response to receiving the master clock signal, the second clock signal being substantially equal to the inverted first clock signal,
a coupling module for push-pull coupling of the first and the second clock signals.
